(19) United States
(12) Patent Application Publication
(10) Pub. No.: US 2007/0132321 A1
(43) Pub. Date: Jun. 14, 2007

(54) Linear compressor

(76) Inventors: Kyeong Bae Park, Seoul (KR); Eon Pyo Hong, Seoul (KR)

Correspondence Address: KED & ASSOCIATES, LLP, P.O. Box 221200, Chantilly, VA, 20153-1200, US

(21) Appl. No.: 11/606,371

(22) Filed: Nov. 30, 2006

(30) Foreign Application Priority Data
Nov. 30, 2005 (KR) 10-2005-0115688

(51) Int. Cl. H02K 41/00; H02K 35/00; F04B 17/04

(52) U.S. Cl. 310/15; 310/13; 417/417

(57) ABSTRACT

A linear compressor is provided. The linear compressor includes a stator, a mover, a compression instrument coupled to the mover and including a cylinder and a piston, and a nonmagnetic conductor which generates a reaction flux to disturb the flow of a leakage flux as an induced flux is generated by the leakage flux through the compression instrument. The linear compressor minimizes leakage flux to the compression instrument to increase efficiency output power of the compressor.

This application claims priority under 35 U.S.C. § 119(a) to Patent Application No. 10-2005-0115688 filed in Korea on Nov. 30, 2005, the entire contents of which is incorporated herein by reference.

### BACKGROUND

1. Field

The field relates to a compressor and, more particularly, to a linear compressor.

2. Background

In a linear compressor, a rectilinear driving force from a linear motor is transferred to a piston, and the piston reciprocates within the cylinder to draw fluid such as refrigerant gas and the like into the cylinder, and discharge the fluid after compression.

### BRIEF DESCRIPTION OF THE DRAWINGS

The embodiments will be described in detail with reference to the following drawings in which like reference numerals refer to like elements wherein:

FIG. 1 is a cross-sectional view of an exemplary linear compressor;

FIG. 2 is a cross-sectional view of a linear compressor in accordance with an embodiment as broadly described herein;

FIG. 3 is an enlarged cross-sectional view of a portion of the linear compressor shown in FIG. 2; and

FIGS. 4-6 are exemplary installations of a compressor as embodied and broadly described herein.

### DETAILED DESCRIPTION

Reference will now be made in detail to various embodiments, examples of which are illustrated in the accompanying drawings. Wherever possible, the same reference numbers will be used throughout the drawings and accompanying description thereof refer to the same or like parts. Although a scroll compressor is presented, merely for ease of discussion, it is well understood that the embodiments as broadly described herein may be applied to different types of compressors, as well as other applications which require fluid pumping.

Descriptions of linear compressors and operation thereof can be found in U.S. Pat. Nos. 7,033,141, 6,571,917, 6,491,506, 6,409,484, 6,299,421, 6,220,393, 6,202,791, 5,993,178, 5,993,175 and 5,945,748, which are subject to an obligation of assignment to the same entity, and the entirety of which is incorporated herein by reference.

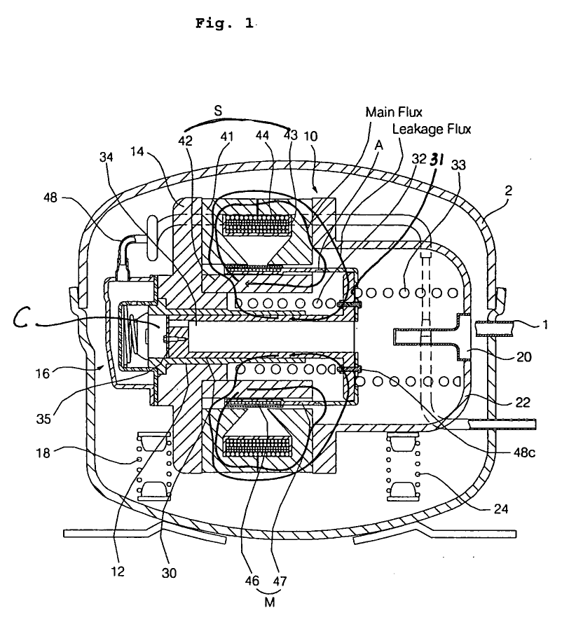

The exemplary linear compressor shown in FIG. 1 includes an air tight container 2 having an intake 1 through which fluid flows from the outside, a linear compression unit 10 which compresses the fluid, and a loop pipe 48 through which fluid compressed by the linear compression unit 10 is discharged to outside the air tight container 2.

The linear compression unit 10 includes a cylinder block 14 having a cylinder 12, a back cover 22 having a suction pipe 20, a piston 30 arranged to reciprocate rectilinearly inside the cylinder 12, and a linear motor which includes a mover M and a stator S which produces a driving force that causes the piston 30 to reciprocate rectilinearly within the cylinder 12. A compression chamber C is formed in front of the cylinder 12 adjacent to the piston 30, and a discharge valve assembly 16 discharges compressed fluid to a loop pipe 48 when fluid in the compression chamber C exceeds a predetermined pressure.

The cylinder block 14 is supported in the air tight container 2, being buffered by a first damper 18. The back cover 22 is also supported in the air tight container 2, being buffered by a second damper 24.

The piston 30 includes a flange 31 which connects the piston 30 to the linear motor. A first spring 32 is arranged between the flange 31 and the cylinder block 14, and a second spring 33 is arranged between the flange 31 and the back cover 22, thus supporting the piston 30 elastically. An inlet path 34, through which the fluid flows, is formed in the piston 30. An inlet valve 35, which opens and closes the inlet path 34, is positioned in front of the piston 30.

The stator S portion of the linear motor includes an outer core 41 positioned between the cylinder block 14 and the back cover 22, an inner core 42 arranged to form a gap with the outer core 41, a bobbin 43 coupled to the outer core 41, and a coil 44 wound on the bobbin 43. The inner core 42 is connected to the cylinder block 14 by bolts (not shown). The mover M portion of the linear motor includes a magnet 46 located between the outer core 41 and the inner core 42 so as to form a gap with the outer core 41 and the inner core 42, and a magnet frame 47 on which the magnet 46 is located, connected with the flange 31 of the cylinder 12 by a joint bolt 48c.

In this exemplary linear compressor, a flow direction of the flux along the outer core 41 and the inner core 42 changes when an alternating current is applied to the coil 44. This generates a force which produces a rectilinear reciprocating motion on the magnet 46 by the change in direction of the flux. The rectilinear reciprocating motion of the magnet 46 is transferred to the piston 30 through the magnet frame 47, and fluid is drawn into the compression chamber C by the rectilinear reciprocating motion of the piston 30, and then discharged after it is compressed.

However, a portion of the flux flowing through the outer core 41 and the inner core 42 may leak into the piston 30 and the cylinder 12. This may cause a decrease in efficiency because of the increase in core loss due to the leakage flux, as illustrated in FIG. 1.

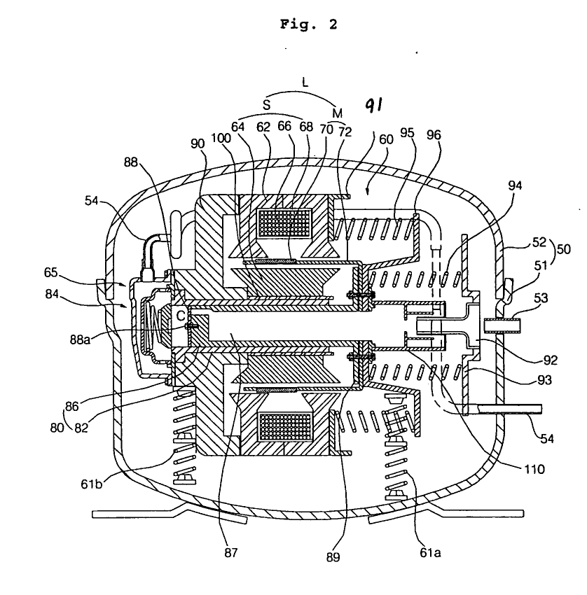

The linear compressor shown in FIG. 2 includes a linear compression unit 60 is installed in an airtight container 50, or casing. The airtight container 50 includes a lower shell 51 and an upper shell 52 positioned atop the lower shell 51. An inlet pipe 53 through which a fluid such as, for example, refrigerant gas and the like, flows into the airtight container 50, penetrates the airtight container 50. A loop pipe 54 through which fluid compressed in the linear compression unit 60 is discharged to outside of the airtight container 50 also penetrates the airtight container 50.

A rear of the linear compression unit 60 is positined on a first damper 61a installed inside the airtight container 50, and a front of the linear compression unit 60 is positioned on a second damper 61b arranged inside the airtight container 50. Thus, the linear compression unit 60 is supported in the airtight container 50, being buffered by both dampers 61a and 61b.

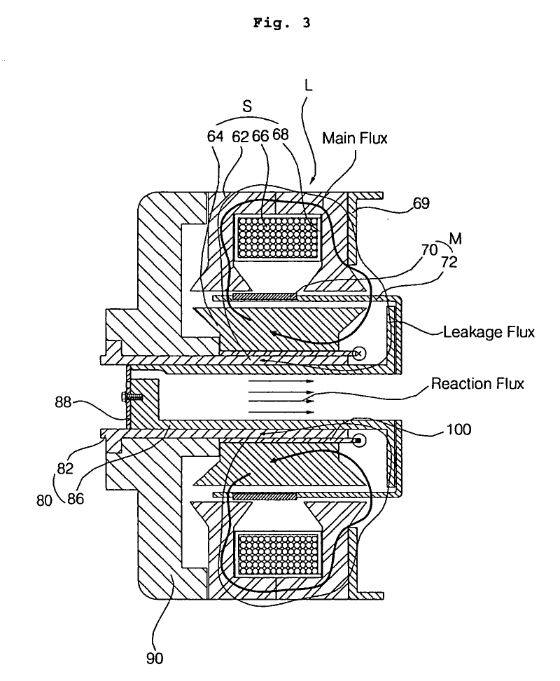

As illustrated in FIGS. 2 and 3, the linear compression unit 60 may include a linear motor L including a stator S and a mover M, and a nonmagnetic conductor 100 to minimize the leakage flux of a compression instrument 80 by generating a reaction flux to counteract the leakage flux passing through the compression instrument 80.

The stator S includes an outer stator core 62, an inner stator core 64 arranged inside and spaced apart from the outer stator core 62, and a coil 66 provided at one side of the outer stator core 62 or the inner stator core 64. In the embodiment shown in FIGS. 2 and 3, the outer stator core 62 is connected to a bobbin 68 on which the coil 66 is wound. Thus, in this embodiment, the coil 66 is provided at the side of the outer stator core 62. A plurality of outer stator cores 62 may be arranged radially on the bobbin 68, spaced apart in the circumferential direction. The stator S also includes a stator cover 69 which covers the outer stator core 62. The stator cover 69 may be made of a magnetic substance, and may be coupled to a cylinder block 90 by a joint bolt or other appropriate fastener.

The mover M includes a magnet 70 which reciprocates rectilinearly due to its interaction with the stator S, and a magnet frame 72 which transfers the rectilinear driving force to the compression instrument 80. In certain embodiments, the magnet frame 72 is made of a magnetic substance.

The compression instrument 80 includes a cylinder 82, and a piston 86 coupled to the mover M, and particularly to the magnet frame 72, for reciprocating rectilinearly into the cylinder 82. In certain embodiments, the cylinder 82 is made of a magnetic substance.

A compression chamber C is formed in front of the cylinder 82, adjacent to the piston 86. A discharge assembly 84 which discharges compressed fluid to the loop pipe 54 when fluid in the compression chamber C exceeds a predetermined pressure is coupled to the compression chamber C. In certain embodiments, the piston 86 is made of a magnetic substance.

A fluid inlet path 87 is formed in a longitudinal direction within the piston 86, and an inlet valve 88 which opens and closes the fluid inlet path 87 is provided in front of the piston 86. In certain embodiments, the inlet valve 88 is an elastic member coupled to the front of the piston 86 by a joint bolt 88a or other suitable fastener. The inlet valve opens and closes the fluid inlet path 87 based on a difference in pressure between the compression chamber C and the fluid inlet path 87. A flange 89 is formed at a rear portion of the piston 86. The flange 89 allows for coupling of the piston 86 and the non-magnetic conductor 100.

The compression instrument 80 includes a cylinder block 90 on which the outer stator core 62 and the inner stator core 64 are provided, a stator cover 91 covering a portion of the outer stator core 62, and a back cover 93 having an inlet pipe 92 which draws fluid into the airtight container 50. In certain embodiments, the cylinder block 90 is made of a nonmagnetic substance and is buffered by second damper 61b, and the stator cover 91 is made of a magnetic substance and is coupled to the cylinder block 90 by a joint bolt or other suitable fastener. The back cover 93 may also be fixed to the stator cover 91 by a joint bolt or other suitable fastener.

The compression instrument 80 may also include a first spring 94 provided between the back cover 93 and the compression instrument 80, a second spring 95 provided between the stator cover 91 and the compression instrument 80, and a spring supporter 96 fixed to the flange 89 of the piston 86 by a joint means such as a joint bolt or other suitable fastener. In certain embodiments, the spring supporter 96 is supported and buffered by the first damper 61a.

The nonmagnetic conductor 100 installed between the stator S and the compression instrument 80, as illustrated in FIG. 3, generates a reaction flux which disturbs the flow of the leakage flux as an induced current is generated by the leakage flux through the compression instrument 80. The nonmagnetic conductor 100 may be made of a nonmagnetic material having a low electric resistance such as, for example, copper, aluminum, and the like., since the reaction flux is theoretically in proportion to the leakage flux when the electric resistance is zero.

In certain embodiments, the nonmagnetic conductor 100 has a cylindrical shape and is installed inside the inner stator core 64 so as to generate an induced current in the circumferential direction inside the inner stator core 64 and a corresponding reaction flux. The nonmagnetic conductor 100 may be installed between the inner stator core 64 and the cylinder 82.

A muffler 110 may be provided at a rear of the piston 86. The muffler 110 helps guide fluid flowing from the inlet pipe 92 of the back cover 93 to the fluid inlet path 87 of the piston 86. The muffler 110 also reduces the noise generated.

Operation of a linear compressor as embodied and broadly described herein will now be discussed.

First, flux flows around the coil 66 when an alternating current is applied to the coil 66. Main flux flowing through the outer core 62 flows to the inner core 64 and then flows through the inner core 64 as illustrated in FIG. 3. However, a portion of this flux leaks out through the piston 86 and the cylinder 82.

An induced current is generated in the circumferential direction by the leakage flux on the nonmagnetic conductor 100. The induced current generates a reaction flux in a direction which disturbs the flow of the leakage flux, such as, for example, opposite the direction of the leakage flux. Then, the leakage flux passing through the piston 86 and the cylinder 82 is minimized by the reaction flux.

The flow direction of the flux on the outer core 62 and the inner core 64 is changed by applying an alternating current and accordingly, a force which causes a rectilinear reciprocating motion is produced on the magnet 70. The rectilinear reciprocating motion of the magnet 70 is transferred to the piston 86 through the magnet frame 72, thus causing the piston 86 to reciprocate rectilinearly together with the magnet 70 and the magnet frame 72.

When the piston 86 moves backward, a strong force is generated with the resonance and amplification by the first and second springs 94 and 95. At the same time, the inlet valve 88 opens the inlet path 87 due to the pressure difference between the compression chamber C and inlet path 87 of the piston 86, thus drawing fluid into the compression chamber C.

When the piston 86 moves forward, a strong force is generated with the resonance and amplification by the first and second springs 94 and 95, and the inlet valve 88 shuts the inlet path 87 of the piston 86 due to the fluid in the compression chamber C and its own elasticity. Subsequently, the fluid in the compression chamber C is pressurized and compressed by the piston 86 and the inlet valve 88, and is discharged through the discharge valve assembly 80 and the loop pipe 54. Fluid in the airtight container 50 passes through the inlet pipe 92 of the back cover 93 and the muffler 110 due to a negative pressure formed in the inlet path 87 of the piston 86, drawing fluid into the inlet path 87 of the piston 86.

A linear compressor as embodied and broadly described herein has an advantage in that the nonmagnetic conductor generates a reaction flux which counteracts the flow of the leakage flux due to the induced current generated by the leakage flux, thus preventing deterioration in efficiency due to the leakage flux.

Additionally, a linear compressor as embodied and broadly described herein has an advantage in that an output power may be increased due to an increase in motor power by minimizing the leakage flux.

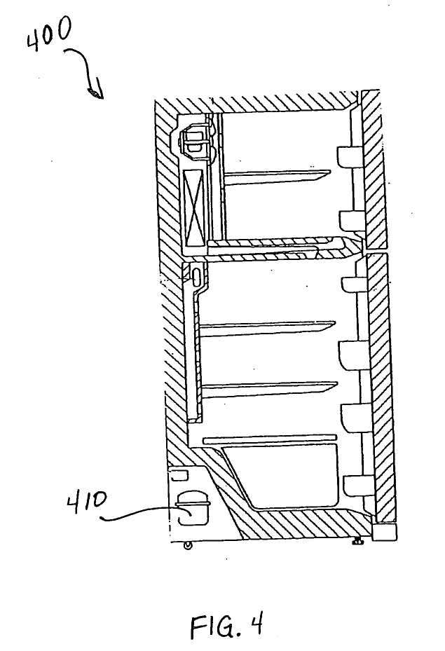

The compressor as embodied and broadly described herein has numerous applications in which compression of fluids is required, and in different types of compressors. Such applications may include, for example, air conditioning and refrigeration applications. One such exemplary application is shown in FIG. 4, in which a compressor 410 as embodied and broadly described herein is installed in a refrigerator/freezer 400. Installation and functionality of a compressor in this type of refrigerator is discussed in detail in U.S. Pat. Nos. 7,082,776, 6,995,064, 7,14,345, 7,055,338 and 6,772,601, the entirety of which are incorporated herein by reference.

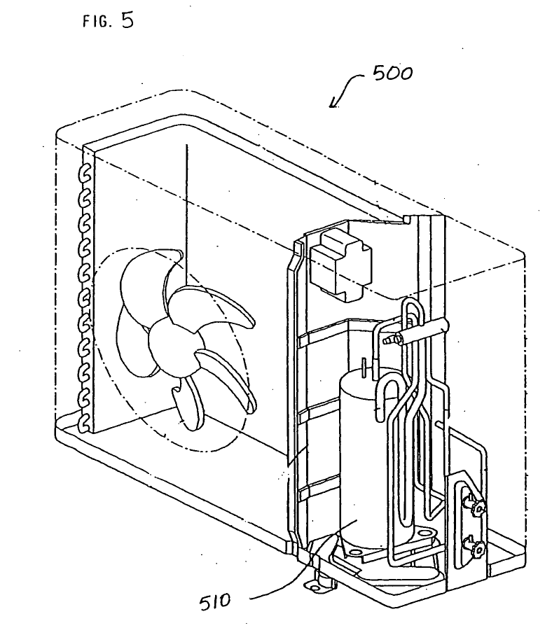

Another such exemplary application is shown in FIG. 5, in which a compressor 510 as embodied and broadly described herein is installed in an outdoor unit of an air conditioner 500. Installation and functionality of a compressor in this type of air conditioner is discussed in detail in U.S. Pat. Nos. 7,121,106, 6,868,681, 5,775,120, 6,374,492, 6,962,058, 6,951,628 and 5,947,373, the entirety of which are incorporated herein by reference.

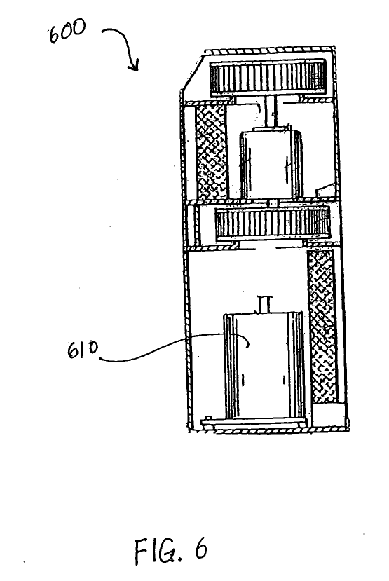

Another such exemplary application is shown in FIG. 6, in which a compressor 610 as embodied and broadly described herein is installed in a single, integrated air conditioning unit 600. Installation and functionality of a compressor in this type of air conditioner is discussed in detail in U.S. Pat. Nos. 7,032,404, 6,412,298, 7,036,331, 6,588,288, 6,182,460 and 5,775,123, the entirety of which are incorporated herein by reference.

Likewise, the system as embodied and broadly described herein is not limited to installation in compressors. Rather, the system as embodied and broadly described herein may be applied in any situation in which the described flux management is required and/or advantageous.

Accordingly, this is directed to a compressor that substantially obviates one or more problems due to limitations and disadvantages of the related art.

An object is to provide a linear compressor that increases output by reducing a core loss due to leakage flux.

A linear compressor as embodied and broadly described herein includes a stator, a mover reciprocating rectilinearly by the interaction with the stator, an instrument unit including a cylinder and a piston connected with the mover to reciprocate rectilinearly into the cylinder, and a nonmagnetic conductor for creating a reaction flux disturbing the flow of a leakage flux according as an induced current is generated by the leakage flux through the instrument unit.

In certain embodiments, the cylinder and the piston are made of magnetic substances.

In certain embodiments, the nonmagnetic conductor is installed between the stator and the instrument unit.

In certain embodiments, the nonmagnetic conductor is made of copper or aluminum and is formed having a cylindrical shape.

A linear compressor as embodied and broadly described herein includes an outer stator core, an inner stator core arranged spaced apart inside the outer stator core, a coil equipped at one side of the outer stator core or the inner stator core, a stator including a stator cover covering the lateral of the outer stator core, a magnet reciprocating rectilinearly by the interaction with the stator and a mover including a magnet frame having the magnet, an instrument unit including a cylinder and a piston connected with the magnet frame and located to reciprocate rectilinearly into the cylinder, and a nonmagnetic conductor for creating a reaction flux disturbing the flow of a leakage flux according as an induced current is generated by the leakage flux leaked through the stator cover, magnet frame, piston and the cylinder.

In certain embodiments, the stator cover, magnet frame, piston and the cylinder are made of magnetic substances.

In certain embodiments, the instrument unit is arranged on the outer circumference of the cylinder and adjacent to the outer stator core and the inner stator core and the instrument unit further includes a cylinder block made of a nonmagnetic substance.

In certain embodiments, the nonmagnetic substance is installed between the inner circumferential surface of the inner stator core and the outer circumferential surface of the cylinder.

In certain embodiments, the nonmagnetic substance is made of copper or aluminum, and is formed having a cylindrical shape.

In alternative embodiments, the linear compressor also includes an inlet valve opening and closing a fluid inlet path formed on the piston, and a discharge assembly forming a compression chamber adjacent to the piston and discharging the compressed fluid when the fluid in the compression chamber is compressed over a predetermined pressure.

A linear compressor as embodied and broadly described herein includes a linear motor, an instrument unit connected with the linear motor for compressing the fluid, and a nonmagnetic conductor for creating a reaction flux disturbing the flow of a leakage flux according as an induced current is generated by the leakage flux leaked from the linear motor to the instrument unit.

In certain embodiments, the nonmagnetic conductor is installed between the linear motor and the instrument unit.

In certain embodiments, the nonmagnetic conductor is made of copper or aluminum, and is formed having a cylindrical shape.

A linear compressor as embodied and broadly described herein has certain advantages, in that the nonmagnetic conductor is established to create the reaction flux disturbing the flow of the leakage flux due to the induced current generated by the leakage flux leaked from the linear motor through the instrument unit, thus preventing the efficiency deterioration due to the leakage flux.

Furthermore, the linear compressor as embodied and broadly described herein has an advantage in that the output power is increased with the increase of motor power constant by minimizing the leakage flux.

Any reference in this specification to “one embodiment,” “an exemplary,” “example embodiment,” “certain embodiment,” “alternative embodiment,” and the like means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiments, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A linear compressor, comprising:
a stator;
a mover configured to reciprocate based on its interaction with the stator;
a compression instrument including a cylinder and a piston coupled to the mover so as to perform a rectilinear reciprocal movement with the cylinder; and
a nonmagnetic conductor configured to generate a reaction flux which disturbs a flow of a leakage flux as an induced flux is generated by the leakage flux through the compression instrument.

2. The linear compressor according to claim 1, wherein the cylinder is made of a magnetic substance.

3. The linear compressor according to claim 1, wherein the piston is made of a magnetic substance.

4. The linear compressor according to claim 1, wherein the nonmagnetic conductor is positioned between the stator and the compression instrument.

5. The linear compressor according to claim 1, wherein the nonmagnetic conductor has a substantially cylindrical shape.

6. The linear compressor according to claim 1, wherein the nonmagnetic conductor is made of at least one of copper or aluminum.

7. A linear compressor, comprising:
a stator including an outer stator core, an inner stator core positioned inside the outer stator core and spaced apart from the outer stator core, a coil provided at one side of the outer stator core or the inner stator core, and a stator cover which covers at least a portion of the outer stator core;
a mover including a magnet configured to reciprocate rectilinearly based on an interaction with the stator, and a magnet frame configured to receive the magnet;
a compression instrument including a cylinder and a piston coupled to the magnet frame so as to reciprocate rectilinearly into the cylinder; and
a nonmagnetic conductor configured to generate a reaction flux which alters a flow of a leakage flux based on an induced current generated by leakage flux which leaks through the stator cover, the magnet frame, the piston and the cylinder.

8. The linear compressor according to claim 7, wherein the stator cover is made of a magnetic substance.

9. The linear compressor according to claim 7, wherein the magnet frame is made of a magnetic substance.

10. The linear compressor according to claim 7, wherein the cylinder is made of a magnetic substance.

11. The linear compressor according to claim 7, wherein the piston is made of a magnetic substance.

12. The linear compressor according to claim 7, wherein the compression instrument is arranged on an outer circumference of the cylinder and includes a cylinder block made of a magnetic substance, wherein the outer stator core and the inner stator core are provided on the cylinder block.

13. The linear compressor according to claim 7, wherein the nonmagnetic conductor is positioned between an inner circumferential surface of the inner stator core and an outer circumferential surface of the cylinder.

14. The linear compressor according to claim 7, wherein the nonmagnetic conductor has a substantially cylindrical shape.

15. The linear compressor according to claim 7, wherein the nonmagnetic conductor is made of at least one of copper or aluminum.

16. The linear compressor according to claim 7, wherein the linear compressor further comprises:
an inlet valve configured to open and close a fluid inlet path formed in the piston; and
a discharge assembly, wherein a compression chamber is formed between an end of the piston and the discharge assembly, and wherein the discharge assembly is configured to discharge compressed fluid when a pressure of fluid in the compression chamber exceeds a predetermined pressure.

17. A linear compressor, comprising:
a linear motor;
a compression instrument coupled to the liner motor and configured to compress a fluid; and
a nonmagnetic conductor configured to generate a reaction flux which disturbs a flow of a leakage flux based on an induced current generated by leakage flux which leaks from the linear motor to the compression instrument.

18. The linear compressor according to claim 17, wherein the nonmagnetic conductor is positioned between the linear motor and the compression instrument.

19. The linear compressor according to a claim 17, wherein the nonmagnetic conductor has a substantially cylindrical shape.

20. The linear compressor according to claim 17, wherein the nonmagnetic conductor is made of at least one of copper or aluminum.
